(19) United States
(12) Patent Application Publication
(10) Pub. No.: US 2024/0302275 A1
(43) Pub. Date: Sep. 12, 2024

(54) ELECTRODE PLATE INSPECTION METHOD, METHOD FOR FABRICATING POWER STORAGE DEVICE, AND ELECTRODE PLATE INSPECTION APPARATUS

(71) Applicants: Prime Planet Energy & Solutions, Inc., Tokyo (JP); Panasonic Production Engineering Co., Ltd., Osaka (JP)

(72) Inventors: Tomomichi YAMAZAKI, Himeji-shi (JP); Tomohide SAKAI, Hirakata-shi (JP); Akihiro SUNOUCHI, Toyonaka-shi (JP); Tomokazu TANINAGA, Neyagawa-shi (JP)

(21) Appl. No.: 18/586,543

(22) Filed: Feb. 26, 2024

(30) Foreign Application Priority Data
Mar. 8, 2023 (JP) 2023-035877

(51) Int. Cl. G01N 21/55; G01N 21/84; G01N 21/88; G01N 21/892; G01N 21/93; H01M 4/02; H01M 4/04

(52) U.S. Cl. CPC G01N 21/55; G01N 21/8422; G01N 21/8806; G01N 21/892; G01N 21/93; H01M 4/0404; H01M 4/0409; G01N 2021/8427; G01N 2021/8822; G01N 2021/8924; H01M 2004/027

(57) ABSTRACT

Inspection of detecting a depression includes obliquely applying linear light extending in a width direction of an electrode plate onto a surface of a coating material, and moving the electrode plate in a longitudinal direction, acquiring specular reflection of the light by the coating material, dividing the acquired specular reflection in the width direction, and obtaining a representative value of lightnesses at multiple positions in the longitudinal direction for each of a plurality of regions in the width direction, obtaining a correction value with which the representative values of lightnesses are uniform among the regions in the width direction, for each of the regions, adding the correction value to the lightnesses of the specular reflection in each of the regions, and detecting a dark portion with a lightness lower than a predetermined threshold, in a lightness distribution of the specular reflection after addition of the correction values.

### CROSS REFERENCE TO RELATED APPLICATIONS

This application claims the benefit of priority to Japanese Patent Application No. 2023-035877 filed on Mar. 8, 2023. The entire contents of this application are hereby incorporated herein by reference.

### BACKGROUND

The present disclosure relates to an electrode plate inspection method, a method for fabricating a power storage device and an electrode plate inspection apparatus.

Japanese Patent Application No. 2017-069131 discloses a method for fabricating a secondary battery including: a coating step of forming a layer of an active material composite on a strip metal foil; a pressing step of the density of an active material layer by pressing; and an inspection step of detecting abnormality of the active material layer. In the inspection step disclosed in Japanese Patent Application No. 2017-069131, abnormality of the thickness of the active material layer, defects in the active material layer, contaminated foreign substance, and so forth are detected as abnormalities.

Japanese Patent Application No. 2021-021579, for example, discloses a lithium precipitation inspection apparatus for detecting lithium precipitated on the surface of a negative electrode composite of a lithium ion secondary battery. In the inspection apparatus disclosed in Japanese Patent Application No. 2021-021579, the negative electrode composite layer is irradiated with white light, and image data of reflected light is obtained, thereby detecting precipitated lithium. The inspection apparatus obtains the image data in an RGB format, and information on each pixel of the image data is converted to a hue angle and a lightness. The inspection apparatus disclosed in Japanese Patent Application No. 2021-021579 determines whether there is a pixel showing a hue angle and a lightness specific to the case of the presence of lithium precipitation.

### SUMMARY

A depression that is lower than its surrounding part is formed on a surface of a coating material in some cases. In inspection of an electrode plate, it is preferable to inspect whether a depression occurs on the coating material or not. In principle, a depression can be found by irradiating the coating material with light to obtain a lightness distribution of reflected light. Since depressions have lower lightness of reflected light than normal portions, the depression can be found. However, pressing of the coating material varies among positions, and accordingly, lightness of reflected light by a normal portion of the coating material also varies among positions. Thus, even if a threshold of lightness for distinguishing the normal portion from depressions is set, depressions cannot be correctly detected in some cases because of variations in lightness in the normal portion.

An electrode plate inspection method proposed here is a method for inspecting an electrode plate in which a coating material containing an active material is applied onto a current collector plate and rolled, and includes inspection of detecting a depression on the coating material. The inspection of detecting the depression includes obliquely applying linear light extending in a width direction of the electrode plate onto a surface of the coating material, and moving the electrode plate relative to the light in a longitudinal direction orthogonal to the width direction, acquiring specular reflection of the light by the coating material, dividing the acquired specular reflection in the width direction, and obtaining a representative value of lightnesses at multiple positions in the longitudinal direction for each of a plurality of regions in the width direction, obtaining a correction value with which the representative values of lightnesses are uniform among the regions in the width direction, for each of the regions in the width direction, adding the correction value to the lightnesses of the specular reflection in each of the regions in the width direction, and detecting a dark portion with a lightness lower than a predetermined threshold and determining the detected dark portion as a depression, in a lightness distribution of the specular reflection after addition of the correction values.

An inspection apparatus for an electrode plate proposed here includes: a conveyor that conveys an electrode plate in which a coating material containing an active material is applied onto a current collector plate and rolled, in a longitudinal direction of the electrode plate; an illuminator that obliquely applies linear light extending in a width direction of the electrode plate onto a surface of the coating material of the electrode plate that is being conveyed by the conveyor; an acquirer that is disposed on a path of specular reflection of light applied by the illuminator by the coating material, and sequentially acquires specular reflection at multiple positions in the longitudinal direction of the coating material; and a determiner that determines whether a depression is present on the coating material. The determiner includes a first processor, a second processor, a third processor, and a fourth processor. The first processor divides the specular reflection acquired by the acquirer in the width direction, and obtains a representative value of lightnesses at the multiple positions in the longitudinal direction for each of a plurality of regions in the width direction. The second processor obtains a correction value with which the representative values of lightnesses are uniform among the regions in the width direction, for each of the regions in the width direction. The third processor adds the correction value to the lightnesses of the specular reflection in each of the regions in the width direction. The fourth processor detects a dark portion with a lightness lower than a predetermined threshold and determines the detected dark portion as a depression, in a lightness distribution of the specular reflection after addition of the correction values.

With the inspection method and the inspection apparatus for the electrode plate, linear light is applied onto the surface of the coating material to obtain specular reflection so that, as compared to the case of diffused illumination, for example, a lightness difference between a normal portion and a depression is large and the normal portion and the depression can be easily distinguished. In addition, the representative value of lightnesses at multiple positions in the longitudinal direction is obtained in each of the regions set in the width direction of the electrode plate and the correction value with which the representative values are uniform is obtained for each of the regions so that variations in lightness among positions on the coating material can be thereby corrected. Accordingly, normal portions after correction have uniform lightness, and thus, depressions can be correctly detected based on the threshold.

### BRIEF DESCRIPTION OF THE DRAWINGS

FIG. 1 is a schematic side view of an electrode plate inspection apparatus.

FIG. 2 is a schematic view of an image of a vicinity of a depression.

FIG. 3 is a flowchart depicting an inspection process of an electrode plate.

FIG. 4 is a graph showing an example of a lightness distribution of specular reflection.

FIG. 5 is a graph showing an average lightness showing an example of a method for calculating a correction value.

FIG. 6 is a graph showing a lightness distribution of specular reflection after correction.

### DETAILED DESCRIPTION

A preferred embodiment of an electrode plate inspection apparatus will be described hereinafter. The preferred embodiment described herein is, of course, not intended to particularly limit the present invention. Each drawing is a schematic view and does not necessarily strictly reflect an actual product. Members and portions having the same functions are denoted by the same reference characters, and description for the same elements and features will not be repeated or will be simplified as appropriate.

### Configuration of Electrode Plate Inspection Apparatus

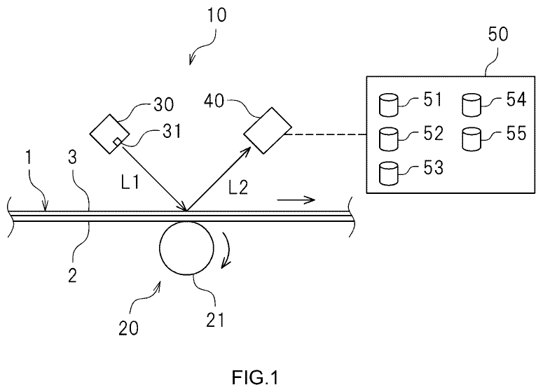

FIG. 1 is a schematic side view of an electrode plate inspection apparatus 10. An electrode plate 1 that is a target to be inspected by the electrode plate inspection apparatus 10 is an electrode of a power storage device, for example, a lithium ion secondary battery. The term “power storage device” herein refers to a general device capable of being repeatedly charged and discharged, and is a concept including chemical batteries such as a lithium ion secondary battery and a nickel-metal hydride battery and physical batteries such as an electric double layer capacitor.

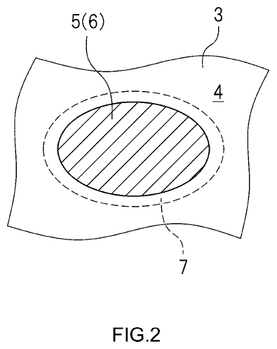

As illustrated in FIG. 1, in the electrode plate 1, a coating material 3 containing an active material is applied onto a current collector plate 2. The electrode plate 1 has a strip shape. The electrode plate inspection apparatus 10 inspects whether a surface of the coating material 3 has a depression 5 (see FIG. 2) or not. The depression 5 is a defect recessed from a surrounding normal portion 4 (see FIG. 2). The electrode plate inspection apparatus 10 performs inspection for the depression 5 on the electrode plate 1 after the coating material 3 is applied onto the current collector plate 2 and rolled (after a pressing step).

In this preferred embodiment, the electrode plate inspection apparatus 10 inspects the negative electrode plate 1 in which the coating material 3 containing a negative electrode active material is applied onto the negative electrode current collector plate 2. In defects in the coating material 3 of the negative electrode sheet 1, positive ions are likely to be precipitated. Thus, inspection for the depression 5 in the negative electrode sheet 1 is more important than that in a positive electrode sheet. The electrode plate inspection apparatus 10 may be used for inspecting whether there is a depression on the positive electrode plate.

As illustrated in FIG. 1, the electrode plate inspection apparatus 10 includes a conveyor 20, an illuminator 30, a reflected light acquirer 40, and a determiner 50 that determines whether a depression 5 (see FIG. 2) is present or not.

The conveyor 20 conveys the electrode plate 1 in a longitudinal direction of the electrode plate 1. The longitudinal direction of the electrode plate 1 is orthogonal to a width direction of the electrode plate 1. As illustrated in FIG. 1, the conveyor 20 includes a conveying roller 21 that is in contact with a surface of the electrode plate 1 opposite to a surface thereof coated with the coating material 3 and conveys the electrode plate 1.

The illuminator 30 obliquely applies linear light L1 (hereinafter also referred to as inspection light L1) extending in the width direction of the electrode plate 1, onto a surface of the coating material 3 of the electrode plate 1 that is being conveyed by the conveyor 20. The illuminator 30 includes an unillustrated light source and a slit 31 that generates the linear inspection light L1.

The acquirer 40 is disposed on a path of specular reflection L2 of the inspection light L1 applied by the illuminator 30 and reflected on the coating material 3. The term “on a path of specular reflection L2” herein refers to a position at which the specular reflection L2 can be substantially obtained, and may be, for example, a position slightly shifted from the calculated center of the path. The acquirer 40 acquires the specular reflection L2 by the coating material 3. The acquirer 40 is, for example, a camera. As the conveyor 20 conveys the electrode plate 1 in the longitudinal direction, the acquirer 40 sequentially acquires specular reflection L2 at multiple positions in the longitudinal direction of the coating material 3. The acquirer 40 acquires specular reflection L2 for each predetermined sampling period, for example. The specular reflection L2 acquired by the acquirer 40 is distributed along the width direction of the electrode plate 1 and is also distributed in the longitudinal direction by sequentially acquiring specular reflection L2 in the longitudinal direction. That is, the acquirer 40 acquires a surface distribution of the specular reflection L2 along the surface of the electrode plate 1.

FIG. 2 is a schematic view of an image of the depression 5 and a vicinity thereof. This image is obtained by imaging a surface distribution of specular reflection L2 along the surface of the electrode plate 1 acquired by the acquirer 40. As illustrated in FIG. 2, the depression 5 is recognized as a dark portion 6 (expressed by hatching in FIG. 2) having a lower lightness than that of the surrounding normal portion 4. Since the acquirer 40 has acquired the specular reflection L2 of the inspection light L1 obliquely applied to the depression 5, the depression 5 in the image is compressed in the longitudinal direction of the electrode plate 1 to have an oval shape. According to the findings of the inventors of the present application, a lightness difference between the normal portion 4 and the depression 5 in conditions for acquiring specular reflection by applying non-diffused light by the slit 31 from the illuminator 30 is larger than that in conditions for acquiring reflected light by applying diffused light from the illuminator 30, for example. Thus, the use of the specular reflection L2 eases detection of the depression 5.

According to the findings of the inventors of the present application, the depression 5 is mainly generated by escape of bubbles in the coating material 3 before the pressing step. In the pressing step, a peripheral portion 7 surrounding the depression 5 and having risen when bubbles were escaped is especially rolled to be smooth. Accordingly, the peripheral portion 7 tends to cause specular reflection of inspection light L1 (hereinafter also referred to as having a high specular reflectance), and has especially high lightness in the image. On the other hand, the depression 5 is not rolled in the pressing step and does not become smooth. Thus, the depression 5 tends to cause diffuse reflection of inspection light L1 (hereinafter also referred to as having a low specular reflectance), and has low lightness in the image.

The determiner 50 is connected to the acquirer 40 and determines whether the depression 5 is present or not on the coating material 3. As illustrated in FIG. 1, the determiner 50 includes a first processor 51, a second processor 52, a third processor 53, a fourth processor 54, and a fifth processor 55. The configuration of the determiner 50 is not particularly limited. The determiner 50 may be incorporated in the electrode plate inspection apparatus 10, and may be, for example, a computer connected to the electrode plate inspection apparatus 10. The determiner 50 may include a storage device (such as a memory) and a computation device (such as a CPU). Each function of the determiner 50 can be appropriately implemented by cooperation of a physical component and a result of computation executed according to a predetermined program.

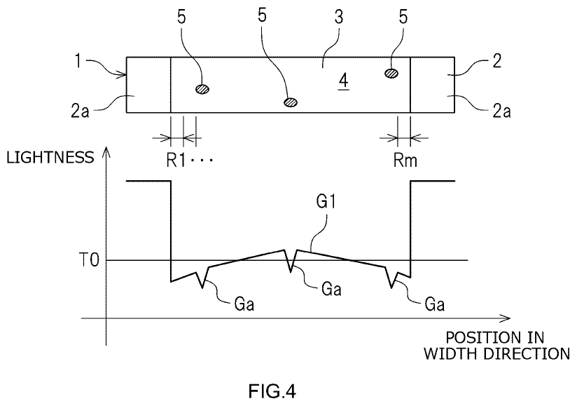

The first processor 51 divides specular reflection L2 acquired by the acquirer 40 in the width direction of the electrode plate 1, and obtains a representative value of lightnesses at multiple positions in the longitudinal direction for each of regions R1 to Rm in the width direction (see FIG. 4). In this preferred embodiment, the first processor 51 calculates average values as the representative values of lightnesses. The representative values of lightnesses at multiple positions are not limited to the average values, and may be, for example, median values.

Pressing of the coating material 3 in the pressing step tends to be strong in a center portion in the width direction and weak in an end portion, which will be described later using an example. Accordingly, the center portion of the coating material 3 in the width direction has high smoothness and high specular reflectance. On the other hand, the end portion of the coating material 3 in the width direction has lower smoothness and lower specular reflectance than those in the center portion. Thus, lightness of the specular reflection L2 varies among the regions R1 to Rm in the width direction. The representative values of lightnesses obtained by the first processor 51 tend to be high in the center portion and lower in the end portion than in the center portion, in the regions R1 to Rm in the width direction.

The second processor 52 obtains a correction value with which the representative values of lightnesses are uniform among the regions R1 to Rm in the width direction, for each of the regions R1 to Rm in the width direction. The third processor 53 adds the correction value obtained by the second processor 52, to the lightness of specular reflection in each of the regions R1 to Rm in the width direction. With this process, a lightness difference of specular reflection L2 in the regions R1 to Rm after correction decreases.

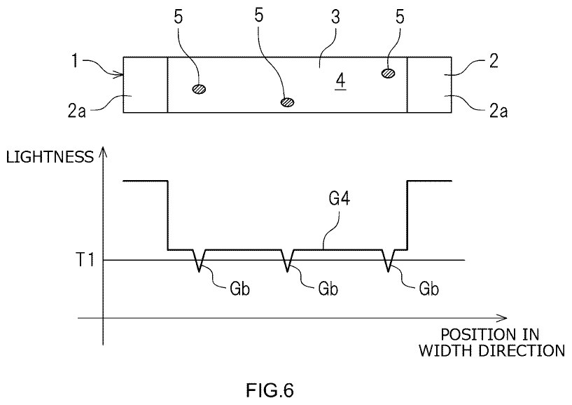

The fourth processor 54 detects a dark portion with lower lightness than a predetermined threshold T1 (see FIG. 6) in a lightness distribution of the specular reflection L2 after the addition of the correction values, and determines the detected dark portion as the depression 5. If the number of detected dark portions 6 each of a size equal to or larger than a predetermined size (see FIG. 2) is a predetermined number or more, the fifth processor 55 determines that the electrode plate 1 is defective.

### Inspection Process of Electrode Plate

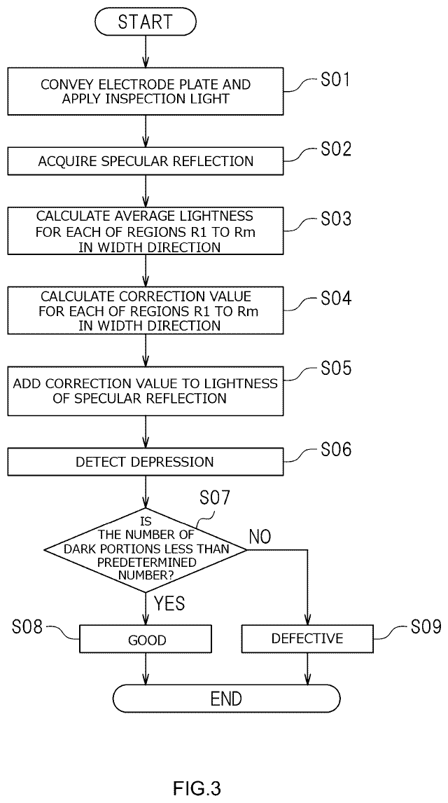

FIG. 3 is a flowchart depicting an inspection process of the electrode plate 1. In inspection of the electrode plate 1, detection of the depression 5 and quality determination of the electrode plate 1 based on the detection are performed. As shown in FIG. 3, in step S01 of inspecting the electrode plate 1, linear inspection light L1 extending in the width direction of the electrode plate 1 is obliquely applied onto a surface of the coating material 3. In addition, in step S01, the electrode plate 1 is moved relative to the inspection light L1 in the longitudinal direction of the electrode plate 1. In this preferred embodiment, the inspection light L1 is immovable and the electrode plate 1 is conveyed by the conveyor 20, but the inspection light L1 may be moved.

In step S02, specular reflection L2 of the inspection light L1 by the coating material 3 is acquired by the acquirer 40. The specular reflection L2 is acquired at multiple positions in the width direction of the electrode plate 1 at the same time, and is also acquired at multiple positions in the longitudinal direction by moving the electrode plate 1 relative to the inspection light L1 in the longitudinal direction of the electrode plate 1. In this preferred embodiment, while the electrode plate 1 is continuously moved in the longitudinal direction, specular reflection L2 is acquired at multiple positions in the longitudinal direction. The method for acquiring distribution of the specular reflection L2 is not limited to this method. The distribution of the specular reflection L2 may be acquired while the electrode plate 1 is intermittently conveyed, for example.

FIG. 4 is a graph showing an example of a lightness distribution of specular reflection L2. Graph G1 in FIG. 4 is a graph showing a lightness distribution of specular reflection L2 at a position in the longitudinal direction. In FIG. 4, the abscissa represents the position in the width direction of the electrode plate 1, and the ordinate represents lightness. A view above graph G1 is a schematic view illustrating the electrode plate 1 at a position corresponding to graph G1.

As shown in graph G1, lightness of specular reflection L2 is large in a center portion of the coating material 3 and is small in an end portion of the coating material 3. However, lightness of the specular reflection L2 can vary with a tendency different from the tendency described above, depending on the pressing step. The mode of variations of lightness of the specular reflection L2 among positions on the coating material 3 is not particularly defined. As shown in FIG. 4, lightness of specular reflection L2 by an uncoated portion 2a of the current collector plate 2 not coated with the coating material 3 is larger than lightness of the specular reflection L2 on the coating material 3.

As shown in the upper view in FIG. 4, it is assumed that a plurality of depressions 5 occur on the coating material 3 in this example. Lightness of each depression 5 is smaller than that of the normal portion 4 surrounding the depression 5. In graph G1, valleys Ga with low lightness represent the depressions 5. The depressions 5 are distinguished based on a lightness difference from the surrounding normal portion 4. However, since the lightness of the normal portion 4 varies among the regions R1 to Rm, even if a common threshold is set in order to distinguish the depressions 5 from the normal portion 4, the depressions 5 cannot be correctly detected in some cases. For example, as shown in FIG. 4, with a threshold T0, the depressions 5 can be detected in a center portion of the regions R1 to Rm. However, in an end portion, lightness of even the normal portion 4 is less than the threshold T0, and the depressions 5 cannot be correctly detected. In this preferred embodiment, this error is solved in a subsequent step.

In step S03, the specular reflection L2 acquired in step S02 is divided in the width direction of the electrode plate 1, and a representative value of lightnesses at multiple positions in the longitudinal direction is obtained for each of the regions R1 to Rm in the width direction. In this preferred embodiment, a predetermined distance (e.g., 1 m) is set as a processing unit, and a representative value is obtained from multiple sets of lightness data acquired while the electrode plate 1 is conveyed to the predetermined distance in the longitudinal direction. That is, the representative value is calculated at each predetermined distance in the longitudinal direction. In this embodiment, an average value is obtained as the representative value. The regions R1 to Rm in the width direction may be set at any possible region within the range of detection resolution of the acquirer 40. By obtaining the representative value of lightnesses at multiple positions in the longitudinal direction, a typical lightness of the normal portion 4 in each of the regions R1 to Rm can be obtained. Even in the presence of the depressions 5 in the regions, the area of the depressions 5 relative to the area of the normal portion 4 is significantly small, and thus, the presence of the depressions 5 hardly affects the representative value of lightnesses.

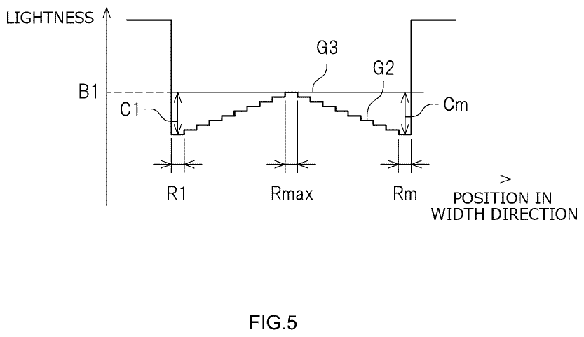

In step S04, a correction value with which the representative values of lightnesses are uniform among the regions R1 to Rm in the width direction is obtained for each of the regions R1 to Rm in the width direction. These correction values are correction values that eliminate a difference in representative values of lightnesses among the regions R1 to Rm in the width direction. These correction values are added to individual representative values of lightnesses in the regions R1 to Rm in the width direction so that the representative values of lightnesses after the addition of the correction values thereby become uniform among the regions R1 to Rm. FIG. 5 is a graph of average lightness showing an example of a method for calculating a correction value. In FIG. 5, graph G2 is a graph of average lightness obtained in step S03. In graph G3, the correction values obtained in step S04 are added to graph G2. With the method shown in FIG. 5, a correction value is determined such that to a region Rmax with the highest average lightness in graph G2, lightnesses in other regions are matched. As shown in FIG. 5, for example, a correction value C1 is set for the region R1, and a correction value Cm is set for the region Rm. Accordingly, as shown in graph G3, average lightnesses in the regions R1 to Rm in the width direction are made uniform. This corrected average lightness will be denoted by B1.

The method shown in FIG. 5 is an example, and the method for calculating the correction value is not limited to the method described above. For example, each correction value may be determined such that the lightness in each of the regions R1 to Rm after correction is equal to a predetermined lightness. In this case, part or all of the correction values may be negative values.

In step S05, the correction value is added to the lightness of the specular reflection L2 in each of the regions R1 to Rm in the width direction. FIG. 6 is a graph showing a lightness distribution of the specular reflection L2 after correction. As shown in graph G4 in FIG. 6, lightnesses of the specular reflection L2 by the normal portion 4 after correction are generally uniform, independently of positions in the width direction of the coating material 3. In addition, the lightness of the specular reflection L2 by the normal portion 4 after correction is close to the average lightness B1 after correction (see FIG. 5). The lightness of the depressions 5 after correction is lower than the lightness of the normal portion 4 after correction.

In step S06, in the lightness distribution of the specular reflection L2 after the addition of the correction values, dark portions Gb with lightness lower than the predetermined threshold T1 are detected, and the detected dark portions Gb are determined as depressions 5. The dark portions Gb in graph G4 correspond to the dark portion 6 in the image of FIG. 2. Lightness of the normal portion 4 after correction is generally uniform independently of the position in the width direction of the coating material 3 through step S05. Accordingly, as shown in FIG. 6, the influence of variations of lightness of the specular reflection L2 among positions on the coating material 3 is reduced, and the depressions 5 can be correctly detected based on the predetermined threshold T1.

The term “predetermined” threshold T1 herein may be a predetermined threshold for the average lightness B1 (or other representative lightness) after correction. For example, the threshold T1 may be defined as a difference from the average lightness B1 after correction. The threshold T1 may be previously determined as an absolute value of lightness. For example, in the case of calculating a correction value such that the average lightness B1 after correction is a predetermined lightness, the threshold T1 may be an absolute value of the lightness. Alternatively, in a case where quality of the pressing step is stable, the threshold T1 may be defined as an absolute value of the lightness without the method for calculating the correction value.

In step S07, it is determined whether the number of detected dark portions 6 each of a size equal to or larger than a predetermined size is a predetermined number or more. As shown in FIG. 3, if the number of dark portions 6 each of a size equal to or larger than the predetermined size (simply referred to as “dark portion” in FIG. 3) is smaller than the predetermined number (i.e., the result of step S07 is YES), the electrode plate 1 is determined to be good regarding depressions 5 in step S08. If the number of detected dark portions 6 each of a size equal to or larger than the predetermined size is the predetermined number or more (i.e., the result of step S07 is NO), the electrode plate 1 is determined to be defective in step S09. In this preferred embodiment, even if dark portions 6 smaller than the predetermined size are detected, these dark portions 6 are not used for defective determination of the electrode plate 1. The size of the dark portion 6 in this preferred embodiment is expressed by the length of the dark portion 6 on the image (see FIG. 2) in the width direction of the electrode plate 1. The size of the dark portion 6 may be expressed by another criterion (e.g., the area of the dark portion 6). The number of the predetermined dark portions 6 may be one, or may be two or more.

### Advantages of Embodiment

Advantages obtained by the electrode plate inspection apparatus 10 according to this preferred embodiment and the inspection method using the apparatus 10 will now be described.

The electrode plate inspection apparatus 10 according to this preferred embodiment includes: the illuminator 30 that obliquely applies linear inspection light L1 extending in the width direction of the electrode plate 1 onto the surface of the coating material 3 of the electrode plate 1 that is being conveyed by the conveyor 20; the acquirer 40 that is disposed on the path of the specular reflection L2 of the inspection light L1 applied by the illuminator 30 by the coating material 3 and sequentially acquires specular reflection L2 at multiple positions in the longitudinal direction of the coating material 3; and the determiner 50 that determines whether the depression 5 is present on the coating material 3 or not. The determiner 50 includes first through fourth processors 51 through 54. The first processor 51 divides the specular reflection L2 acquired by the acquirer 40 in the width direction of the electrode plate 1 and obtains a representative value of lightnesses at multiple positions in the longitudinal direction of the electrode plate 1 in each of the regions R1 to Rm in the width direction. The second processor 52 obtains a correction value with which the representative values of lightnesses are uniform among the regions R1 to Rm in the width direction, for each of the regions R1 to Rm in the width direction. The third processor 53 adds the correction value to the lightness of the specular reflection L2 in each of the regions R1 to Rm in the width direction. The fourth processor 54 detects the dark portion Gb with a lightness lower than the predetermined threshold T1 and determines the detected dark portion Gb as the depression 5, in the lightness distribution of the specular reflection L2 after the addition of the correction values. From the reasons described above, the electrode plate inspection apparatus 10 can correctly detect the depression 5, independently of variations of lightness of the specular reflection L2 among positions on the coating material 3.

In this preferred embodiment, the first processor 51 is configured to calculate the average values as the representative value of lightness. In the case of this preferred embodiment, there is supposed to be no significant bias in lightness at multiple positions in the longitudinal direction of the electrode plate 1. Thus, the average value has high reliability as a representative value of multiple values.

In this preferred embodiment, the determiner 50 includes the fifth processor 55 that determines the electrode plate 1 as defective if the number of detected dark portions 6 each of a size equal to or larger than the predetermined size is the predetermined number or more. With this configuration, dark portions 6 smaller than the predetermined size are not used for defective determination of the electrode plate 1. Accordingly, an increase in defect rate of the electrode plate 1 due to excessive quality can be prevented.

In this preferred embodiment, the electrode plate 1 is a negative electrode plate in which the coating material 3 containing the negative electrode active material is applied onto the current collector plate 2 and rolled. In defects of the coating material 3 of the negative electrode sheet 1, positive ions are likely to be precipitated. Thus, inspection for the depressions 5 is especially important in the negative electrode sheet 1.

One preferred embodiment of the electrode plate inspection apparatus proposed here has been described above. The preferred embodiment described above, however, is merely an example, and the present disclosure can be carried out in other modes. The preferred embodiment described above does not limit to the present disclosure unless otherwise specified. The technique disclosed here can be modified in various ways, and the constituent elements and the processes described here can be appropriately omitted or appropriately combined unless no particular problems arise.

The specification includes the disclosures described in the following items.

### Item 1

An electrode plate inspection method for inspecting an electrode plate in which a coating material containing an active material is applied onto a current collector plate and rolled, the method including:
inspection of detecting a depression on the coating material, wherein
the inspection of detecting the depression includes
   obliquely applying linear light extending in a width direction of the electrode plate onto a surface of the coating material, and moving the electrode plate relative to the light in a longitudinal direction orthogonal to the width direction, acquiring specular reflection of the light by the coating material,
   dividing the acquired specular reflection in the width direction, and obtaining a representative value of lightnesses at multiple positions in the longitudinal direction for each of a plurality of regions in the width direction,
   obtaining a correction value with which the representative values of lightnesses are uniform among the regions in the width direction, for each of the regions in the width direction,
   adding the correction value to the lightnesses of the specular reflection in each of the regions in the width direction, and
   detecting a dark portion with a lightness lower than a predetermined threshold and determining the detected dark portion as a depression, in a lightness distribution of the specular reflection after addition of the correction values.

### Item 2

The electrode plate inspection method of Item 1, wherein
the representative value of lightnesses is an average value.

### Item 3

The electrode plate inspection method of Item 1 or 2, wherein
the inspection of detecting the depression includes determining that the electrode plate is defective if the number of detected dark portions each of a size equal to or larger than a predetermined size is a predetermined number or more.

### Item 4

The electrode plate inspection method of any one of Items 1 to 3, wherein
the electrode plate is a negative electrode plate in which a coating material containing a negative electrode active material is applied onto a current collector plate and rolled.

### Item 5

A method for fabricating a power storage device, including the electrode plate inspection method of any one of Items 1 to 4.

### Item 6

An inspection apparatus for an electrode plate including:
a conveyor that conveys an electrode plate in which a coating material containing an active material is applied onto a current collector plate and rolled, in a longitudinal direction of the electrode plate;
an illuminator that obliquely applies linear light extending in a width direction of the electrode plate onto a surface of the coating material of the electrode plate that is being conveyed by the conveyor;
an acquirer that is disposed on a path of specular reflection of light applied by the illuminator by the coating material, and sequentially acquires specular reflection at multiple positions in the longitudinal direction of the coating material; and
a determiner that determines whether a depression is present on the coating material, wherein
the determiner includes
   a first processor that divides the specular reflection acquired by the acquirer in the width direction, and obtains a representative value of lightnesses at the multiple positions in the longitudinal direction for each of a plurality of regions in the width direction,
   a second processor that obtains a correction value with which the representative values of lightnesses are uniform among the regions in the width direction, for each of the regions in the width direction,
   a third processor that adds the correction value to the lightnesses of the specular reflection in each of the regions in the width direction, and
   a fourth processor that detects a dark portion with a lightness lower than a predetermined threshold and determines the detected dark portion as a depression, in a lightness distribution of the specular reflection after addition of the correction values.

### Item 7

The electrode plate inspection apparatus of Item 6, wherein
the first processor calculates an average value as the representative value of lightnesses.

### Item 8

The electrode plate inspection apparatus of Item 6 or 7, wherein
the determiner includes a fifth processor that determines the electrode plate as defective if the number of detected dark portions each of a size equal to or larger than a predetermined size is a predetermined number or more.

### Item 9

The electrode plate inspection apparatus of any one of Items 6 to 8, wherein
the electrode plate is a negative electrode plate in which a coating material containing a negative electrode active material is applied onto a current collector plate and rolled.

What is claimed is:

1. An electrode plate inspection method for inspecting an electrode plate in which a coating material containing an active material is applied onto a current collector plate and rolled, the method comprising:
inspection of detecting a depression on the coating material, wherein
the inspection of detecting the depression includes
obliquely applying linear light extending in a width direction of the electrode plate onto a surface of the coating material, and moving the electrode plate relative to the light in a longitudinal direction orthogonal to the width direction,
acquiring specular reflection of the light by the coating material,
dividing the acquired specular reflection in the width direction, and obtaining a representative value of lightnesses at multiple positions in the longitudinal direction for each of a plurality of regions in the width direction,
obtaining a correction value with which the representative values of lightnesses are uniform among the regions in the width direction, for each of the regions in the width direction,
adding the correction value to the lightnesses of the specular reflection in each of the regions in the width direction, and
detecting a dark portion with a lightness lower than a predetermined threshold and determining the detected dark portion as a depression, in a lightness distribution of the specular reflection after addition of the correction values.

2. The electrode plate inspection method according to claim 1, wherein
the representative value of lightnesses is an average value.

3. The electrode plate inspection method according to claim 1, wherein
the inspection of detecting the depression includes determining that the electrode plate is defective if the number of detected dark portions each of a size equal to or larger than a predetermined size is a predetermined number or more.

4. The electrode plate inspection method according to claim 1, wherein
the electrode plate is a negative electrode plate in which a coating material containing a negative electrode active material is applied onto a current collector plate and rolled.

5. A method for fabricating a power storage device, including the electrode plate inspection method according to claim 1.

6. An electrode plate inspection apparatus comprising:
a conveyor that conveys an electrode plate in which a coating material containing an active material is applied onto a current collector plate and rolled, in a longitudinal direction of the electrode plate;
an illuminator that obliquely applies linear light extending in a width direction of the electrode plate onto a surface of the coating material of the electrode plate that is being conveyed by the conveyor;
an acquirer that is disposed on a path of specular reflection of light applied by the illuminator by the coating material, and sequentially acquires specular reflection at multiple positions in the longitudinal direction of the coating material; and
a determiner that determines whether a depression is present on the coating material, wherein
the determiner includes
a first processor that divides the specular reflection acquired by the acquirer in the width direction, and obtains a representative value of lightnesses at the multiple positions in the longitudinal direction for each of a plurality of regions in the width direction,
a second processor that obtains a correction value with which the representative values of lightnesses are uniform among the regions in the width direction, for each of the regions in the width direction,
a third processor that adds the correction value to the lightnesses of the specular reflection in each of the regions in the width direction, and
a fourth processor that detects a dark portion with a lightness lower than a predetermined threshold and determines the detected dark portion as a depression, in a lightness distribution of the specular reflection after addition of the correction values.

7. The electrode plate inspection apparatus according to claim 6, wherein
the first processor calculates an average value as the representative value of lightnesses.

8. The electrode plate inspection apparatus according to claim 6, wherein
the determiner includes a fifth processor that determines the electrode plate as defective if the number of detected dark portions each of a size equal to or larger than a predetermined size is a predetermined number or more.

9. The electrode plate inspection apparatus according to claim 6, wherein
the electrode plate is a negative electrode plate in which a coating material containing a negative electrode active material is applied onto a current collector plate and rolled.
